(19) United States
(12) Patent Application Publication
(10) Pub. No.: US 2013/0066797 A1
(43) Pub. Date: Mar. 14, 2013

(54) Method for Identifying, Employing, Retaining and Compensating Motivated Workers in a Business using an Ownership Experience Franchise Model

(71) Applicants: James Myers, Reston, VA (US); Joseph Ferraro, Edgewater, NJ (US)

(72) Inventors: James Myers, Reston, VA (US); Joseph Ferraro, Edgewater, NJ (US)

(21) Appl. No.: 13/608,641

(22) Filed: Sep. 10, 2012

Related U.S. Application Data
(60) Provisional application No. 61/532,147, filed on Sep. 8, 2011.

(51) Int. Cl. G06Q 10/06

(52) U.S. Cl. 705/321

(57) ABSTRACT

Disclosed is a franchise-style business method that incorporates a system of identifying, evaluating, hiring and recruiting qualified candidates, managing employees in smaller franchise cells and providing franchise owners with an ownership experience model otherwise absent in most organizations. The system entails identifying candidates, and thereafter tracking the performance of each franchise cell within the larger organization. The performance of the individual franchises determines their compensation, placing emphasis on higher work quality, output and developed business. Highly skilled and entrepreneurial candidates are given the opportunity to lead franchises within the larger organization, recruit and hire high performing employees and define their franchise business objectives. Greater employee satisfaction results in higher employee retention and improved employee performance, which improves efficiency and revenue for the overall organization.

### CROSS REFERENCE TO RELATED APPLICATION

This application claims the benefit of U.S. Provisional Application No. 61/532,147 filed on Sep. 8, 2011, entitled “Business Process.” The above identified patent application is herein incorporated by reference in its entirety to provide continuity of disclosure.

### BACKGROUND OF THE INVENTION

1. Field of the Invention

The present invention relates to a method of identifying, hiring, retaining and motivating employees through a management and reward system. More specifically, the present invention relates to a method of recruiting, retaining, compensating and managing employees using an ownership experience that parallels a franchise system but differs in the matter of startup costs or risks.

Most businesses today rely on traditional employment methods for hiring and maintaining employees and large staffs. These methods generally include the standard interview practices to review qualifications, employment history and personality, and thereafter follow with an employment offer, agreement or contract that is based on tenure, the given type of job and a defined salary range. After being hired, the employee performance and progression are tracked against sometimes esoteric performance metrics and goals, which ultimately determine the employee's raises and promotions. The overall success of the organization and the individual effort of the employee are not always aligned or represented using traditional performance tracking, and further the employee's pay and incentive structure does not always reflect his or her work ethic, quality and output. Highly technical functions and highly skilled job positions are particularly suffering from this hiring and compensation model, as younger, more energized employees and the dawn of the information age has made it easier to transition between jobs rapidly, as opposed to staying in the same position and attempting to change a seemingly static situation. Particularly motivated employees reject the notion of a stable position for job security, and generally regard lack of advancement or recognition of skills as a notice to look elsewhere for employment, where they can leverage their skills to broaden their experience, add value and avoid complacency or stagnation. The end goal is work satisfaction, recognition and finally reaping the rewards of hard work, while avoiding the disenfranchised feel of most corporate structures and their nonexistent or disconnected incentive programs.

Technical and professional positions in particular are becoming increasingly difficult to fill and stay filled. It is common that once these employees are recruited and hired through traditional methods and channels (recruiting firms, job fairs, ads, internet, etc.), employees often leave to find other jobs and better prospects for advancement, recognition and pay. The common reasons for leaving include more pay and incentives, the willingness to take on increased responsibility previously not offered, or because the process in which they were hired lacked full human life-cycle risk and reward, motivation, and career progression desired by the employee. Employee to employer loyalty and employer to employee loyalty therefore suffers. A “what is in it for me?” or “if you win, do I win?” internal discussion often quickly begins to enter the minds of employees, where traditional job placement, recruitment, retainment and rewards systems do not provide a remedy and have thus far been lacking or at a minimum have placed the employee incentives out of balance with regard to their job requirements. Simply stated, technical, professional, managerial and administrative organizations are all experiencing difficulty recruiting qualified candidates, preventing high employee attrition rates, optimizing the management of their employees to incentivize workplace performance. As a result, these organizations fail to maximize the performance potential of their employees and thus fail to reap the potential financial rewards of having a highly motivated workforce.

The purpose of the present invention is to provide a business process that provides a system of recruiting, hiring, compensating, managing, and maintaining an organization of technical, professional, managerial, or administrative staff using a specifically designed employment experience like no other, from job to owner experience model that creates a bond between the employee and other employees, and thus to the organization as a whole. The ownership experience model is similar to a franchise model, where worker recognition and incentives are more closely aligned with those of the organization, and thus motivation is derived through business success and linked to employee effort. As will be detailed in the foregoing disclosure, the method contemplates identifying a group of top leaders with an organization and allowing these employees to have the opportunity to expand their role in their company by actively participating in recruiting, training, and metrics supervision in their work environment. This allows these top leaders and performers to show their true potential in their specific field, gain management experience and obtain compensation that directly links the company performance to their financial success.

The present method outlines a business process that promotes, enables and manages a controlled employee and employer ecosystem. When implemented accordingly, this outlined ecosystem is self-sustaining, delivering improved operations as well as stable and predictable business results through an employment-to-career-to-ownership process. The present model is a composition of business processes, compensation ingredients, and “progression accelerators” that provide a unique work and life experience that deliver a complete employee to business owner experience without the risk of the traditional “franchise” startup costs, ownership, and related liabilities. The employee to business ownership experience should be viewed as more of a business partnership, rather than a work contract or franchise agreement. The company's ultimate objective is not to just hire and retain skilled employees, but to provide an opportunity for skilled individuals to progress rapidly in a performance based model that provides motivated participants with the gratification of a defined and self-guided career, as well as the security of stable employment within the organization. Those candidates that are more career and entrepreneurial minded, and who would normally have to work years to rise to the level of “partner” or “franchisee” status will be able to obtain a variation of such an ownership in an organization early on, increasing their income and status at their own pace based on their level of understanding of the business, as well as personal work ethic and leadership abilities. The employee is thus given a greater ability to advance while also placing a higher burden of performance on the employee because he or she has a more direct link or stake in the success of the company or business.

2. Description of the Prior Art

Devices have been disclosed in the prior art that relate to hiring, recruitment and business incentive methods. These include methods that have been patented and published in patent application publications, and generally relate to franchise models for business success through outsourcing and offering incentivized franchise systems for franchise-style businesses and their existing managers. The forgoing is a list of devices deemed most relevant to the present disclosure, which are herein described for the purposes of highlighting and differentiating the unique aspects of the present invention, and further highlighting the drawbacks existing in the prior art.

Specifically, U.S. Published Patent Application Publication No. 2003/0097319 to Moldovan discloses a method for business solutions that contemplates increasing company performance and profitability through a number of different avenues, including developing capital investment and lowering costs through outsourcing to expand business, optimize tax strategies related to outsourcing using joint ventures, and further for paying workers, management, local owners and contractors compensation. The Moldovan disclosure is limited to improving a business through alternative methods of performing manufacturing work and efficiently facilitating the manufacturing through ventures that are beneficial to the company, both in taxation and efficiency. The present invention, alternatively, is directed to a management and franchise method that identifies motivated employees, increases retention and also increases performance by sharing ownership in the overall organization in exchange for worker effort and quality.

Further, U.S. Published Patent Application Publication No. 2007/0219845 to Crane discloses a micro-franchise business method that establishes a process and system for service industry personnel to obtain a personal stake in the organization and to have personal ownership of their work, increasing quality for the customer, success of the organization and personal wealth of the worker. Owner, manager and laborer are combined in this model to ensure top quality products and services for the customer. The laborer has ownership of the business and cannot hire others to do his or her job, replacing the traditional business model that breeds complacency in those without a personal stake in the organization. The model is contemplated for jobs in the direct and/or personal service industry, and provides a means to motivate otherwise unmotivated groups of workers. While providing a motivator for workers and including a franchise-type model, the Crane method fails to contemplate the first identification and hiring of candidates by their entrepreneurial capabilities and willingness to succeed. The Crane method further fails to contemplate how such a micro-franchise system would be implemented in larger organizations, as provided in the present method, and is more directed to direct service industries rather than technical and professional fields.

Finally, U.S. Published Patent Application Publication No. 2002/0128909 to Scrivano discloses a method of allowing managers of a business to become owners of that business in a franchise agreement, wherein a screening process and incentive system allows the manger to be chosen and then earn credits that facilitate purchase of the franchise at a reduced cost from its origination. The manager is qualified for a loan for the franchise, after which the manager works within an incentive system where he or she can earn credits to reduce the purchase price, providing the manager motivation to achieve goals and increase productivity. At the end of a predetermined time period, the bonuses and discounts are applied to the purchase price for the manager to become owner of the franchise. The Scirvano method allows hard working candidates to be chosen for management positions, after which the manager can work to achieve discounts on a future bid to purchase the business franchise being managed. This provides the manager motivation to increase the business value and productivity. The present invention similarly incorporates a franchise model, but in contrast the model is utilized as a means to motivate technical employees through an accelerated career path, ownership stake and financial rewards derived through hard work.

The present invention provides a franchise ownership experience model for use in companies as a means to recruit, identify and adequately retain and compensate strong performers. The goal is to increase work performance by identifying and recognized skilled employees, allowing those employees to grow a base of similarly minded hard workers, and provide them with financial benefits aligned to their work performance and the overall performance of the organization. The organization and the individual employees both benefit from this employment structure and the associated method of hiring and rewarding employees. It is submitted that the present invention is substantially divergent in steps and processes from the prior art, and consequently it is clear that there is a need in the art for an improvement to existing hiring, recruiting and employment methods. In this regard the instant invention substantially fulfills these needs.

### SUMMARY OF THE INVENTION

In view of the foregoing disadvantages inherent in the known types of employment methods now present in the prior art, the present invention provides a new franchise employment method that can be utilized for identifying, retaining, and rewarding highly motivated and technical employees through a franchise-style ownership experience model.

It is therefore an object of the present invention to provide a new employment method that has all of the advantages of the prior art and none of the disadvantages.

It is another object of the present invention to provide an employment method that incentivizes performance, tenure and recruitment of highly skilled employees through a franchise style model.

Another object of the present invention is to provide an employment method that links individual employee performance with the success of the organization, where benefits are seen by the employee for high quality performance and the organization receives the benefit of satisfied employees and a high work product.

Another object of the present invention is to provide an employment method that allows high performing employees to become franchise style owners that recruit and maintain small groups of skilled employees. Hiring, paying and managing these individuals remain the responsibility of the parent organization or company. Selecting like-minded, high performing individuals is the main priority of the ownership model.

Yet another object of the present invention is to provide an employment method that incorporates a system of tracking performance metrics of small franchise cells within larger organizations, where the cells are groups of employees managed by a highly motivated and ordained employee that posses the necessary entrepreneurial skills and motivation to expand the business and share in the revenue of the individual cell based on its performance.

A final object of the present invention is to provide an employment method that improves the loyalty and relationship between employees and employers, wherein the employee is given more responsibility and ability to share in organization profit, while the employer is repaid with the hard work of its employees and increased employee retention that results. The present method is designed to be ‘viral’ in nature, where the overall hard work and motivation of employees is increased as the franchise cells become more popular and employees feel more rewarded and satisfied in their work. This is reinforced as the employees within a group are also financially tied their group's performance.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a schematic of the present method, where a predictable performance hiring model is utilized to identify candidates for ownership and management of smaller franchise cells.

FIG. 2 shows a representation of the Skill Profile Index for a specific employee based on defined criteria, wherein the results are utilized in the predictable performance hiring model.

FIG. 3 shows a view of the personal ownership experience ecosystem developed through the management and ownership of franchise cells within the larger organization.

FIG. 4 shows the ownership experience model that develops from the deployment of franchise cells, where the owner of the franchise is given ownership and management duties for running the local cell.

FIG. 5 shows the advantages and opportunities for employees involved in the franchise method cells.

FIG. 6 shows the hiring method of the present invention in use, and the associated system for identifying motivated employees that can manage franchises within the organization.

FIG. 7 shows the system for managing and tracking performance of all franchise cells within the larger organization, where this information is used to determine individual cell performance and incentives.

### DETAILED DESCRIPTION OF THE INVENTION

Reference is made herein to the attached drawings. Like reference numerals are used throughout the drawings to depict like or similar elements of the present employment method. For the purposes of presenting a brief and clear description of the present invention, the preferred embodiment will be discussed as used for increasing employee satisfaction and rewards, while also increasing productivity of organizations and therefore increase organizational success. The figures are intended for representative purposes only and should not be considered to be limiting in any respect.

The present invention provides a new management system that includes a franchise-based organization in highly skilled employment companies, and a payment system that identifies qualified and motivated candidates for placement in positions of leadership. The system further provides rewards for those employees aligned with the performance of their franchise cells and aligned with the overall performance of the organization. A defined system of identifying and selecting candidates for a franchise cell is disclosed, whereafter a system of managing the franchise cells is provided. The cell management system tracks cells within the larger organization for determining each cell performance and ultimately for determining their rewards and incentives. The present method is designed for technical service industries, including software developers, computer technicians and various engineering organizations. While it is submitted that the present invention fits well in technical service industries, it is not desired to limit the deployment of the present franchise-style management method to a single industry, but rather to disclose a working method that may be deployed across industry boundaries.

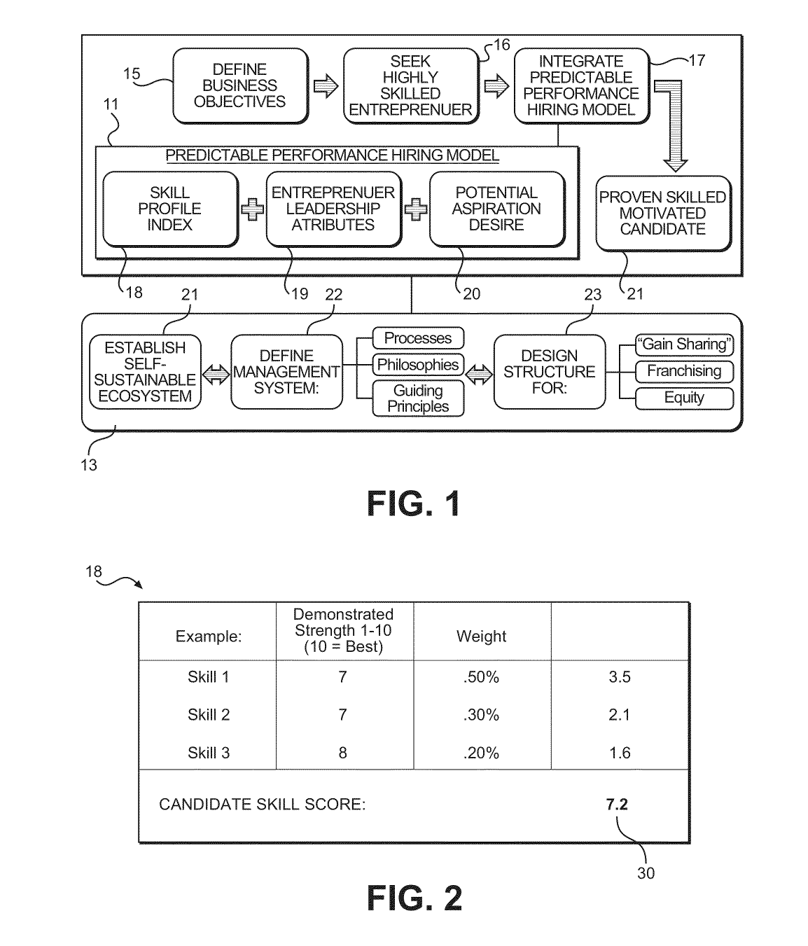

Referring now to FIG. 1, there is shown a layout of the overall hiring, managing and ownership experience method of the present invention. The method initiates with identifying highly motivated employees from within the organization and from external sources. A predictable performance hiring model encapsulates a means and system of identifying these candidates, and further for providing them with increased roles within the organization where their entrepreneurial skills, management skills and motivation will be utilized as a means to drive performance in local teams or organizations, referred to as franchise cells within the larger organization. The predictable performance hiring model comprises several steps that align the franchises with the needs of the overall organization and identify candidates that would be well suited for a franchise management role.

The first step for the organization is to identify and define the organization business objectives 15. This involves defining of the business objectives and/or the requirements for the organization and the desired outcome of implementing the franchise model. Would this particular organization or business benefit from smaller employee groups that operate as growing franchises and that are locally managed? Would this type of structure drive innovation, improve customer and employee satisfaction and drive performance of the overall organization? Defining the goals of the organization and further defining the appropriateness of the present method for the given organization is a first step in the process. The roles and responsibilities of the next generation of highly successful companies, their leaders, and managers, will be a direct result of how they prepare for the future. Successful organizations will have symmetry between the company outcome based objectives, results and progression of their employees, and specifically their leaders. The roles and responsibilities should be specifically defined around managing the business and pay particular attention to employee satisfaction and engagement. The defined business objectives 15 must include the distribution of profit and the elements that directly control cost, efficiency, quality, and repeatability that ultimately reflect on production, revenue and profit to the employee.

Once the business objectives 15 have been defined and the goals of the organization are established, candidates are identified to lead local franchises within the organization. These candidates are recruited, interviewed and selected using a system that weighs different metrics against the business goals and the desired attributes for the position. In determining the appropriate individuals to lead these franchise cells, a Highly Skilled Entrepreneur (HSE) 16 outreach program is utilized. HSE 16 is a step of attracting those employees or outside individuals that are highly motivated and wish to have more involvement in the organization beyond being a salaried employee. A campaign to identify those with management skills, and the motivation to create and manage their own franchise cells is initiated, after which applicants are reviewed and interviewed to determine successful candidates. Those interested in the program are evaluated using a predictable performance hiring model 11, which identifies the attributes of the candidate and evaluates his or her capabilities and experience against the requirements of the franchise cell management position. Those candidates who meet the standards of the system are provided the opportunity to lead their own franchise cell. The franchise owner can then choose his or her own employees to staff the franchise, utilizing the same predictable performance hiring model 11 thereafter.

The predictable performance hiring model 11 uses three primary evaluation steps and a system that tracks each candidate's performance in the steps to determine who is a sufficiently skilled and motivated candidate 21 for the program. The first step in the model is the Skill Profile Index (SPI) 18. The Skill Profile Index prioritizes the skills needed to fulfill a specific organization requirement or position, and scores the candidate based on his or her qualifications for the position. This step of the process provides a standard test (based on the individual business) that will demonstrate and assess the candidate's ability to succeed in the position and determine if the candidate meets the minimum threshold of skills required therefor. As shown in FIG. 2, as the candidate is interviewed, a system 18 of tracking responses and weighing each response is utilized. The system 18 includes the job requirements for the position, after which the demonstrated strength of the candidate for the specific requirement or skill is cataloged, weighted and tabulated to provide an overall candidate skill score 30 for the given position. Each individual skill required for the position is ranked and weighed in order of importance and relevance to the position, after which a cumulative score will be taken from the candidates' demonstration of his or her skills and abilities. This step is necessary to determine if the candidate meets the minimum requirements threshold for the position, and comes prior to evaluating the candidate on more subjective or intangible criteria that follows in the process.

Following the SPI evaluations 18 is the step of evaluating the candidate for his or her entrepreneurial skills and ambition. This step includes determining the Entrepreneurial Leadership Attributes (ELA) 19 of the candidate, which is a critical evaluation for determining whether the candidate will be successful in a business ownership and management role required when managing a franchise cell. Beyond being technically qualified and having the required background, the candidate must possess a willingness to be a self-starter, motivator and manager of other employees within their individual cell, all while increasing the performance, recruiting other skilled employees and increasing the franchise client base/market share. The ELA 19 is an Index utilized to highlight the candidates with leadership attributes and self-motivation. Defining these attributes allows the business to sort the ‘generic employees’ who are complacent in their position from those individuals who are driven and motivated by an internal desire to succeed in a leadership and entrepreneurial setting. These self-starters will be rewarded for their ability to lead, train, mentor, and coach others on the day-to-day operations that they themselves conduct for the business. Similar to the Skill Profile Index 18, the ELA Index 19 takes a cumulative score of the leadership and entrepreneurial skills that the candidate demonstrates utilizing a metric system 18 similar to that shown in FIG. 2. The importance of each leadership attribute will be prioritized base on the available organizational positions in order to maximize the relevance, efficiency, and overall production potential of the candidate in the position if hired.

The final step in the predictable performance hiring model 11 is determining the potential, aspiration and desire of the candidate using a similar index as the SPI 18 and ELA 19 indexes. In this step, a Potential/Aspiration/Desire (PAD) index 20 is utilized to probe intangibles of the candidate that are proven markers of a future successful candidate. In order to meet long term business objectives, the PAD index 20 is a key ingredient to creating a predictable hiring model and to ensuring consistently high performance of the business and its functions. In contrast to the SPI 18 and ELA 19 indexes, the PAD index 20 will look at the demonstrated experience of the candidate. The experience of the candidate will be evaluated using outcome based questions designed to reveal the core driver of the candidate's behavior, motivation and aspirations. This assessment tests the candidate's belief system, defines the reward structure and determines the survival skills of the applicant.

The predictive performance hiring model 11 incorporates the three evaluation indexes, the SPI 18, ELA 19, and PAD 20 indexes, to determine who is a proven skilled and motivated candidate 21 that can be placed in a position managing a franchise cell 13. The franchise cell 13 is a localized organization within the larger organization, where a single franchise “owner” is an employee manager that is able to manage a smaller group of employees, direct operations for the group, improve market share or client base and control hiring in and out of his or her cell 13. The operator of the cell is able to establish a self-sustaining ecosystem 21 with respect to the larger organization, where the cell performance enhances the performance of the larger organization, and the franchise cell manager/owner is able to obtain greater recognition and rewards based on his or her cell performance. The cell is also free of micromanagement, and is more independent and freely operating. This requires the franchise cell owner to be more motivated than a standard employee, and have an entrepreneurial spirit that wills his group to succeed. The owner is able to freely define a management system and set of business objectives for the cell, which align with the overall goals of the larger organization. The cell organization and method of operating can be tailored to a specific industry, specific set of work projects or focus, where the output and performance of the cell is designed 23 to motivate the included employees/owner and to increase success of the cell.

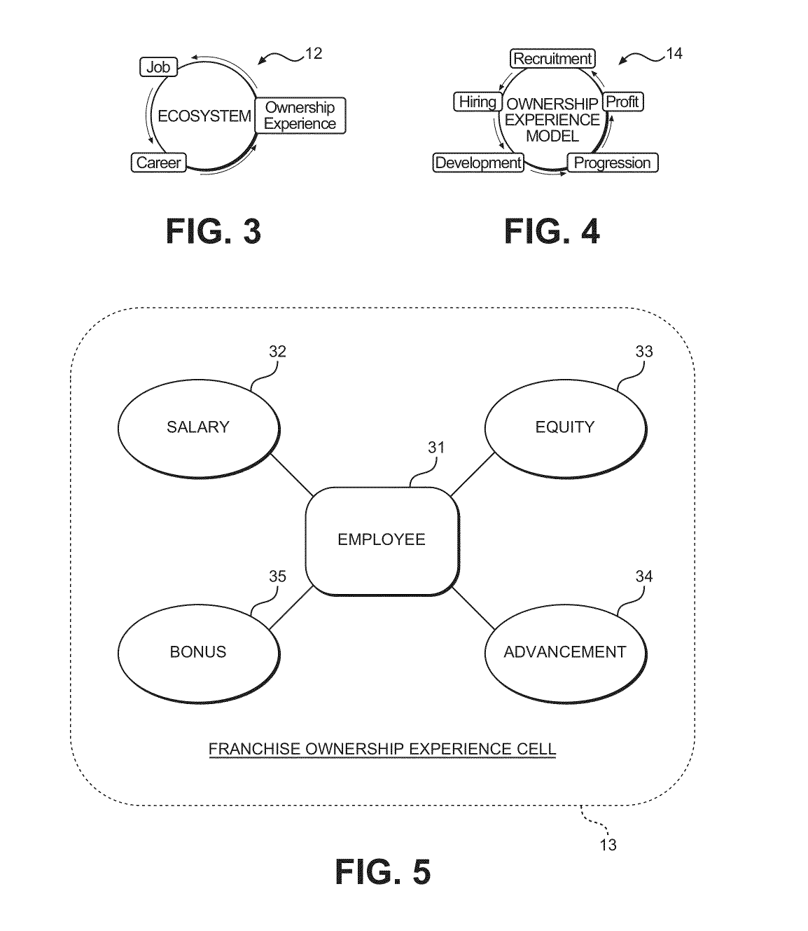

What develops out of the smaller cells is greater cohesion between employees within the cell, independence of the cell from the larger organizational bureaucracy and ultimately greater work satisfaction and output for the individual employees involved. The manager/owner of the franchise cell establishes an ecosystem in relation to the larger organization, and furthers a personal ecosystem 12 that incorporates his roles in the job, career satisfaction and a stake in the success of his cell, which is ultimately an ownership experience. The personal ecosystem 12, as shown in FIG. 3, is a balance between the cell owner's job, career and the ownership experience, which is fundamental in implementing the overall franchise cell method effectively. The personal ecosystem 12 defines the employee expectations and payoff. These defined expectations are essential to success of the employee and thus the success of the business, since they surround the employee with opportunity and ownership experience in the business.

The roles of each franchise owner are defined through an ownership experience model 14 similar to that shown in FIG. 4. Once a candidate is vetted and selected based on the evaluation model 11, the candidate is given the opportunity to operate a franchise cell of other employees under his or her ownership and guidance. The franchise owner is given the freedom to hire, recruit and develop employees of his or her choosing, define the work hours and projects of interests, and further monitor the progression and pay of each employee. The franchise is paid from the larger organization, which utilizes a performance tracking system to determine work performance and revenue brought back to the organization, and if the particular cell is achieving its defined objectives and criteria as negotiated with the larger organization. The franchise owner is given a salary plus the rewards of profit sharing for the franchise cell, incentivizing local performance of the cell and the employees therein. The owners, after being evaluated and chosen, agree to a defined ownership financial model that outlines pay from the larger organization and sets expectations. Revenue above thresholds is dispersed based on the particular agreements for each cell, where the owner shares in the profits and can pay his or her employees more or less depending on their performance.

The ownership path is therefore an alternate disposition or course of employment over direct employment with defined wages and little to no bonus or profit sharing plan. As shown in FIG. 5, each cell 13 consists of an employee owner 31, wherein the owner 31 is compensated in number of ways beyond base salary, with the tradeoff coming in the form of higher workload, greater responsibility and higher leadership requirements. The owner shares in the profits of the cell, including receiving bonuses 35, salary 32 and equity share 33 in the organization. The employee owner is further recognized for his or her performance with the cell 13 and provided the opportunity for advancement 34 in the larger organization.

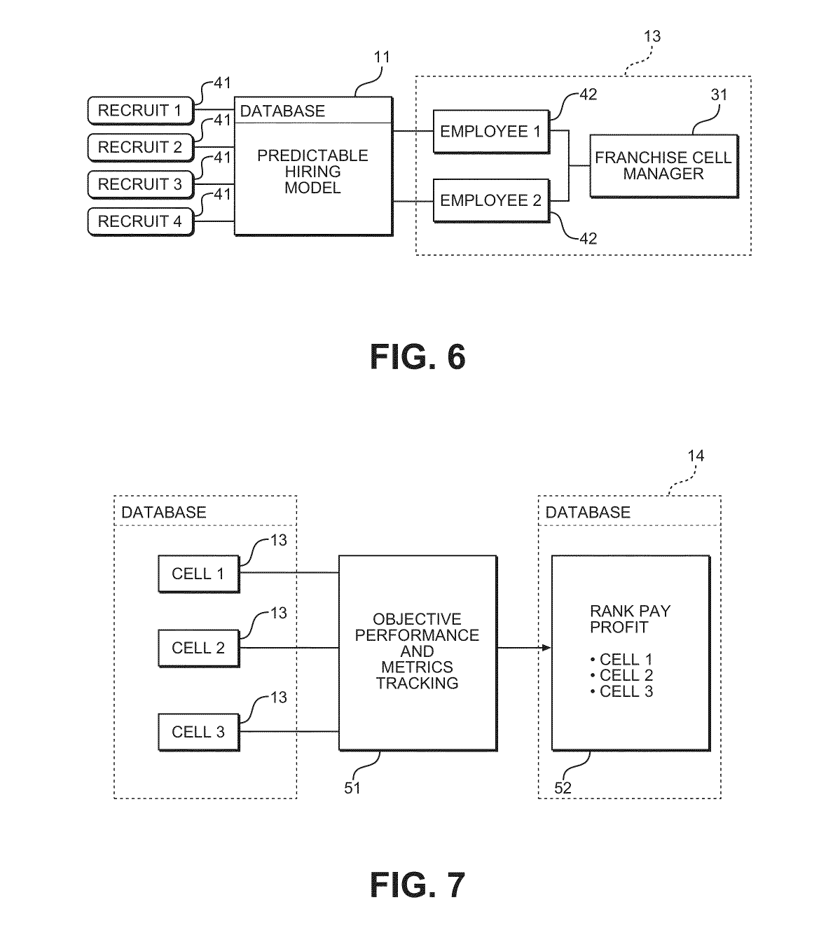

Referring now to FIG. 6, there is shown a flowchart view of the predictable hiring model system utilized to identify candidates for ownership positions of franchise cells. In this system, recruits 41 respond to a campaign or job posting and are interviewed individually. The recruits are placed into a database 11, which includes their personal information, the results of their interviews and the weighted scores for the SPI 18, ELA 19 and PAD 20 indexes. An algorithm tabulates the scores based on desired weights for each index, which are determined by the hiring managers at the initiation of the franchise or by the franchise owner after its conception, where different criteria are given different weight based on their input. In FIG. 6, successful employees 42 are taken from the database and placed under a franchise owner 31 within a specific cell 13. This system is the same for determining a single successful employee 42 who becomes the franchise cell manager 31.

Referring now to FIG. 7, there is shown a view of the present method tracking system for all franchise cells 13 within a larger organization. The franchises 13 are all monitored within a database, including the financials, business objectives and member profile information of each. The financials records and objective goals are tracked and calculated 51 for each cell using a specific algorithm that looks at the franchise growth, revenue, expenses and goal achievement. The metrics developed in the tracking system 51 are utilized in a second database 14 to determine profit sharing for each cell based on performance. The cells are compared to one another and provided rewards for hitting targets and achieving goals set out at the beginning of a review period and cataloged thereafter. In this way, the franchises are kept accountable to the overall organization, and further awarded for high performance with respect to their franchise agreements and their agreed upon goals.

As a practical example, the present method is herein presented in use in the software development and service industry:

Large software companies sometimes experience delays in their annual software release schedule because of its inability to recruit, hire and retain a sufficient number of field engineers to support its customers using their deployed software. When customers purchase the company's software, they also purchase a certain amount of field engineer support hours each year. As a result of strong demand for the support hours and the competing demand by the company for core software development cycles, the company is unable to hire and retain sufficient numbers of field engineers in adequate skill to meet the demand. As a result, the company's software developers, whose primary role is to develop and design new versions of the software, are deployed into the field to support customers and meet the demand. Despite this “re-deployment” effort, which takes place on a yearly cycle, the company still may or may not be able to meet client support hour demand. It is also important to note that field support is a very high margin product for the company so not meeting demand causes revenue and profitability shortfalls for the company. Another negative consequence of the redeployment of research and development resources is that it detracts from the company's ability to innovate and develop new products, as well as introduce new releases of existing products.

Implementation of the present franchise method works to solve this problem by creating a system whereby qualified candidates are identified, hired, managed and retained to support the company's business in smaller groups or cells. The cells operate with freedom from the larger organization, hiring skilled employees, deploying them in the field and growing their client base in a competitive environment between cells. The employer and employee goals are aligned and loyalty between the two increases. High performing employees who also possess a desire for advancement and those that demonstrate entrepreneurial skills become part of and further extend the franchise and organization “ecosystem” by assisting in the identification and recruiting of other high potential candidates. Thus the process becomes ‘viral,’ as high potential candidates join the company, succeed, demonstrate their entrepreneurial skills and identify other candidates that may prove successful as franchise owners. Specifically applying the model to the aforementioned industry and company, candidates would be sourced through various channels including traditional and non-traditional (e.g. social media websites) sources and mediums.

Once seemingly qualified candidates are identified, the present method would be utilized as previously described: 1) candidates' skills are evaluated using the Skill Profile Index. Each identified skill receives a weight and candidates' skills are assessed on an absolute scale and then aggregated across the weights. Candidates must possess minimal skill set scores in order to be qualified. 2) In the next step, candidates' entrepreneurial skills and attributes are evaluated using the Entrepreneurial Leadership Attributes (ELA) index. This assessment determines a candidate's self-motivation and entrepreneurial skills. These skills are an important part of the overall business process in terms of identifying, when combined with results of the skill profile index, not only those candidates that are likely to be both successful individual contributors but also their ability to recruit and manage other candidates. 3) Following the ELA index, the candidate undergoes the final step of the hiring process: the Potential Aspiration & Desire (PAD) index assessment which assesses motivational aspects of the candidate's behavior. 4) Successful candidates are then hired and their performance is managed by combining all elements of the hiring assessment process to ensure alignment with the company's core values and objectives. During the first year, performance assessment and calibration sessions are conducted on a quarterly basis and then on an annual basis thereafter. 5) Candidates having scored high remarks on performance and entrepreneurial skills are then provided with the opportunity to recruit other highly qualified candidates with similar skills. By doing so, the employees become not only part of the recruiting\hiring process, but also part of the company “franchise.” 6) Once referred candidates are screened, hired and working at the company, their performance in turn will drive the compensation for the employee who hired the candidate. This aspect is very important and a unique part of the overall process. As an example, if an employee is hired and performing at far exceeding level, then the employee who referred the candidate would receive a percentage bonus to the performing employee base pay. The successful franchise cells are those that hire high performing candidates, allow for freedom of operation of their employees and fulfill their business objectives with respect to their clients and the overall organization.

Returning to the above example software company scenario, it is contemplated that software engineers which possess particular skills would become part of a franchise cell or “entity within an entity” in that company. This inner entity may be virtual, spanning geographic boundaries, or it may be specific to certain geographical areas (e.g. New York City). The employees would help grow their particular cell or entity by recruiting successive waves of employees, which can be deployed in the field in response to customer demand and in the place of core business needs such as software designing and new product development.

The present system includes components for recruiting, candidate assessment, training, employee performance management, employee/owner ownership structure, compensation, leadership engagement, and employee entry/exit/spinoff mechanisms. Once all components are applied, the process improves aspects of employee management by creating a greater degree of employee engagement and freedom within a larger organization. Additionally, the system creates unique business ownership experiences for skilled individuals who would normally have to work years to obtain “Partner” or “Franchisee” status. The systems of the present method include the ability to monitor this management method, including cataloging each recruit and each cell, tracking their performance and determining their incentives based on that performance. It is contemplated that a unique system be implemented that tracks billable hours, employee progress and franchise performance for the larger organization to manage the large number of smaller franchises thereunder.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in steps, form, function, manner of operation and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A franchise ownership experience and employment method in an organization, comprising the steps of:
cataloging, calculating and weighting candidates using a predictable performance hiring model and system, said hiring model further comprising a skill profile index, an entrepreneurial leadership attributes index, and potential aspiration and desires index, and said system comprising a computer software stored on memory to calculate a candidate weighted score based on said index responses;
utilizing said predictable performance hiring model to hire franchise cell owners;
allowing franchise cell managers to hire, manage and direct franchise employees;
tracking the performance for each of said franchise cell using a computer software stored on memory to calculate cell revenue, profits, employee pay and business growth;
paying each of said franchise owners based on their respective franchise cell performance.

2) The device of claim 1, wherein said skill profile index further comprises the steps of:
evaluating a candidate's skills with respect to said franchise business, wherein a list of requirements are provided with requirement weights depending on importance, said computer software stored on memory to calculation determining a candidate overall score.

3) The device of claim 1, wherein said entrepreneurial leadership attributes index further comprises the steps of:
evaluating a candidate's subjective qualifications for being a self-starter, motivator and manager of other employees, wherein a list of requirements are provided with requirement weights depending on importance, said computer software stored on memory to calculation determining a candidate overall score.

4) The device of claim 1, wherein said potential aspiration and desires index further comprises the steps of:
evaluating a candidate's intangible qualifications and goals for being hired, wherein a list of requirements are provided with requirement weights depending on importance, said computer software stored on memory to calculation determining a candidate overall score.
